(19) United States
(12) Patent Application Publication
(10) Pub. No.: US 2026/0203853 A1
(43) Pub. Date: Jul. 16, 2026

(54) Image processing device and image processing method

(71) Applicant: REALTEK SEMICONDUCTOR CORPORATION, HSINCHU (TW)

(72) Inventors: TSUNG-HSUAN WU, HSINCHU (TW); CHING-SHENG CHENG, HSINCHU (TW)

(21) Appl. No.: 19/424,855

(22) Filed: Dec. 18, 2025

(30) Foreign Application Priority Data
Jan. 14, 2025 (TW) 114101556

(51) Int. Cl. G06T 1/60

(52) U.S. Cl. CPC G06T 1/60

(57) ABSTRACT

An image processing device is used to receive an input image data that includes multiple frames, and at least one of the frames contains at least one packet. The image processing device includes a receiving circuit, a storage circuit, a transmission circuit, and a control circuit. The receiving circuit receives the input image data. The storage circuit is used to store the at least one packet. The transmission circuit is used to output a current output image data. The control circuit is used to read at least one target packet from the storage circuit according to the current output image data, adjust the at least one target packet, and then output the at least one target packet through the transmission circuit.

### BACKGROUND OF THE INVENTION

### Field of the Invention

The present invention generally relates to image processing, and more particularly, to the adjustment of data packets in an image.

### Description of Related Art

Modern visual interfaces (e.g., High Definition Multimedia Interface (HDMI), DisplayPort (DP), etc.) commonly use a data packet transmission mechanism. The data packet is used to transmit audio/video auxiliary data, including the metadata and the control information. These pieces of information are crucial for the correct display and processing of audiovisual content, such as automatic audio and/or video synchronization, high dynamic range imaging (HDR) video, and advanced color formats, etc. Therefore, providing the correct data packet at the appropriate time point is important to ensure the correct display of the image data.

### SUMMARY OF THE INVENTION

In view of the issues of the prior art, an object of the present invention is to provide an image processing device and an image processing method, so as to make an improvement to the prior art.

According to one aspect of the present invention, an image processing device is provided. The image processing device receives an input image data. The input image data includes multiple frames, and at least one of the frames includes at least one packet. The image processing device includes a receiving circuit, a storage circuit, a transmission circuit, and a control circuit. The receiving circuit receives the input image data. The storage circuit is coupled to the receiving circuit and configured to store the at least one packet. The transmission circuit is coupled to the receiving circuit and configured to output a current output image data. The control circuit is coupled to the storage circuit and the transmission circuit and configured to read at least one target packet from the storage circuit according to the current output image data, to adjust the at least one target packet, and then to output the at least one target packet through the transmission circuit.

According to another aspect of the present invention, an image processing method is provided. The image processing method is applied to an image processing device. The image processing device receives an input image data. The input image data includes multiple frames, and at least one of the frames includes at least one packet. The image processing method includes the following steps: receiving the input image data; storing the at least one packet to a storage circuit; and, according to a current output image data, reading at least one target packet from the storage circuit, adjusting the at least one target packet, and then outputting the at least one target packet.

The technical means embodied in the embodiments of the present invention can solve at least one of the problems of the prior art. Therefore, compared to the prior art, the present invention can ensure the correct display of the image data.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is a functional block diagram of the image processing device according to an embodiment of the present invention.

FIG. 2 is a flowchart of the image processing method according to an embodiment of the present invention.

FIG. 3 is a schematic diagram of a frame's coordinates.

FIG. 4A is a schematic diagram of an application example according to the present invention.

FIG. 4B is a schematic diagram of another application example according to the present invention.

FIG. 5 shows sub-steps of step S230.

FIG. 6 is a schematic diagram of another application example according to the present invention.

FIG. 7 shows sub-steps of step S230.

FIG. 8 is a schematic diagram of another application example according to the present invention.

FIG. 9 shows sub-steps of step S230.

FIG. 10 is a functional block diagram of the image processing device according to another embodiment of the present invention.

FIG. 11 is a flowchart of the image processing method according to another embodiment of the present invention.

FIG. 12 is a functional block diagram of the image processing device according to another embodiment of the present invention.

FIG. 13 is a flowchart of the image processing method according to another embodiment of the present invention.

FIG. 14 is a functional block diagram of the image processing device according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an image processing device and an image processing method. On account of that some or all elements of the image processing device could be known, the detail of such elements is omitted provided that such detail has little to do with the features of this disclosure, and that this omission nowhere dissatisfies the specification and enablement requirements. Some or all of the processes of image processing method may be implemented by software and/or firmware and can be performed by the image processing device or its equivalent. A person having ordinary skill in the art can choose components or steps equivalent to those described in this specification to carry out the present invention, which means that the scope of this invention is not limited to the embodiments in the specification.

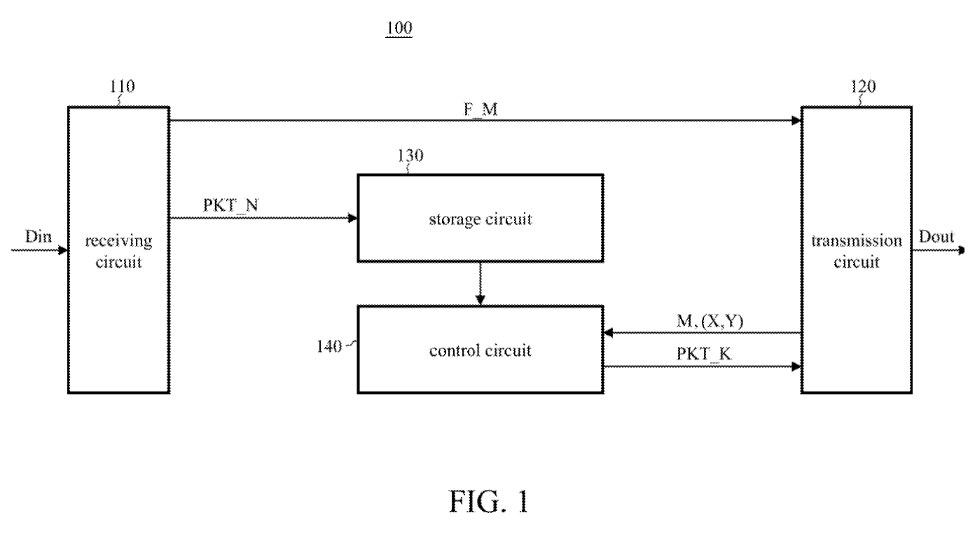

Reference is made to FIG. 1, which is a functional block diagram of an image processing device according to an embodiment of the present invention. The image processing device 100 includes a receiving circuit 110, a transmission circuit 120, a storage circuit 130, and a control circuit 140, all of which are coupled to one another. The storage circuit 130 may be a memory (e.g., a dynamic random access memory (DRAM)) or a buffer circuit. The control circuit 140 may be a logic circuit.

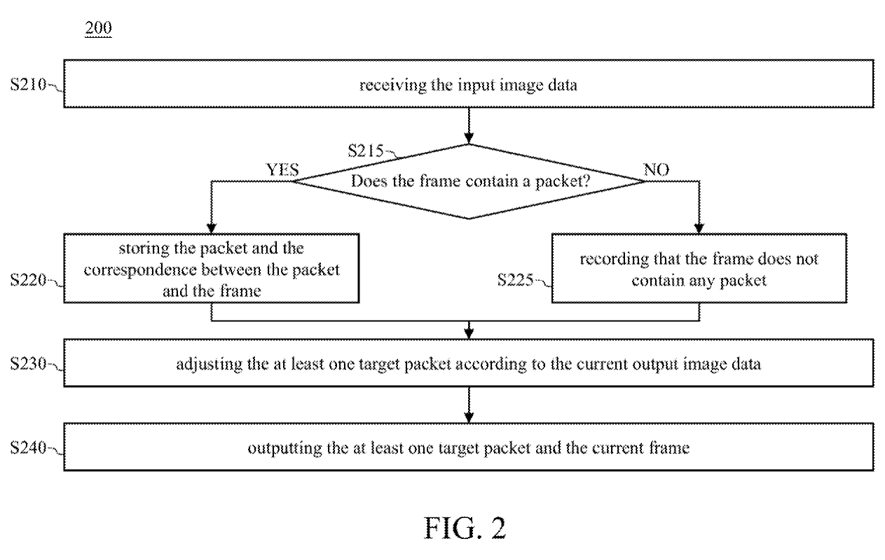

Reference is made to FIG. 2, which is a flowchart of the image processing method 200 according to an embodiment of the present invention. The image processing method 200 can be executed by the image processing device 100. When the image processing method 200 is in the form of software or firmware, the control circuit 140 may be a circuit or electronic component with programming execution capability, such as a central processing unit (CPU), a microprocessor, a microcontroller, a micro-processing unit, a digital signal processor (DSP), or an equivalent circuit. The control circuit 140 implements the image processing method 200 by executing the code and/or program instructions stored in the storage circuit 130.

The image processing method 200 includes the following steps.

Step S210: The receiving circuit 110 receives the input image data Din. The input image data Din contains multiple frames (F_M, where M is the frame number, M=0, 1, 2, …), and each frame contains no data packet or contains at least one data packet PKT_N (hereinafter, the data packet is abbreviated as the packet). N is the packet number, which can be represented as M-P, where P is the packet number (P=0, 1, 2, ...). For example, PKT_0-1 represents the first packet of the 0^{th} frame. The control circuit 140 processes frames that require packet adjustment.

Step S215: The receiving circuit 110 determines whether the frame F_M contains a packet. If YES, then the flow proceeds to step S220; otherwise, the flow proceeds to step S225.

Step S220: The receiving circuit 110 stores the at least one packet PKT_N to the storage circuit 130, and stores the correspondence between the at least one packet PKT_N and the frame to the storage circuit 130. In some embodiments, the correspondence can be stored by storing the packet number. For example, it is possible to determine the correspondence from the packet number “M-P” (i.e., the packet is the P-th packet of the M-th frame).

Step S225: The receiving circuit 110 records, in the storage circuit 130, that the frame F_M does not contain any packet.

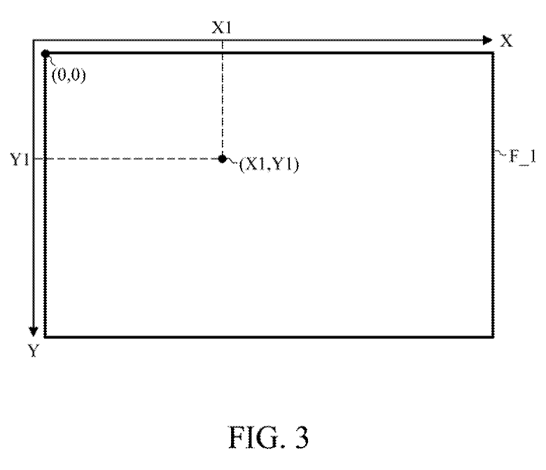

Step S230: The control circuit 140 adjusts the target packet according to the current output image data Dout. The transmission circuit 120 outputs the current output image data Dout. The current output image data Dout contains multiple frames, and each frame contains multiple pixels. In some embodiments, the current output image data Dout contains a frame that the transmission circuit 120 is outputting (hereinafter referred to as the current frame), a frame number of the current frame, and a pixel position ((X,Y)) being output (hereinafter referred to as the current pixel position (X,Y)). For example, referring to FIG. 3, the current output image data Dout may contain the pixel at position (X1,Y1), which is the X1-th pixel in the Y1-th row, of the frame F_1 (with the frame number M being 1).

The adjustment operation of the target packet includes but is not limited to reading the target packet PKT_K from the storage circuit 130, and then providing the target packet PKT_K to the transmission circuit 120 at the appropriate time point. The control circuit 140 provides the target packet to the transmission circuit 120 at an appropriate time point, which is equivalent to inserting the target packet in the current frame.

In other embodiments, the current output image data Dout includes the time of the image data (e.g., the current playback time of the current pixel position (X,Y)). Specifically, each frame corresponds to a specific playback time; the control circuit 140 can calculate the current playback time corresponding to the current pixel position (X,Y) based on the resolution of the current frame and the current pixel position (X,Y).

Step S240: The transmission circuit 120 outputs the target packet PKT_K and the current frame.

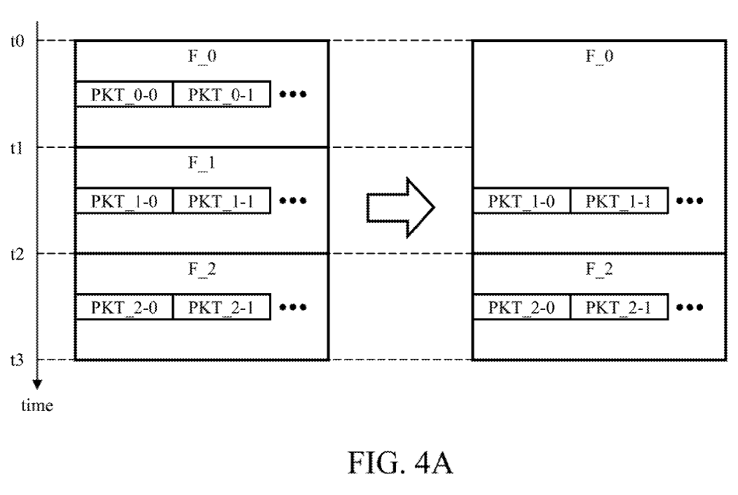

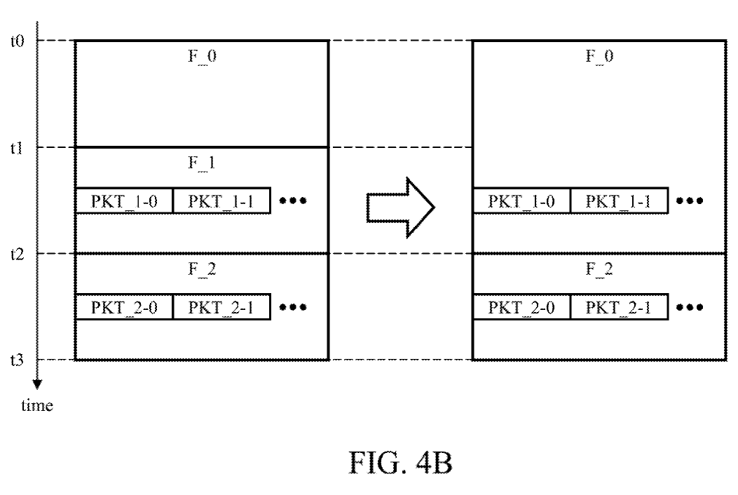

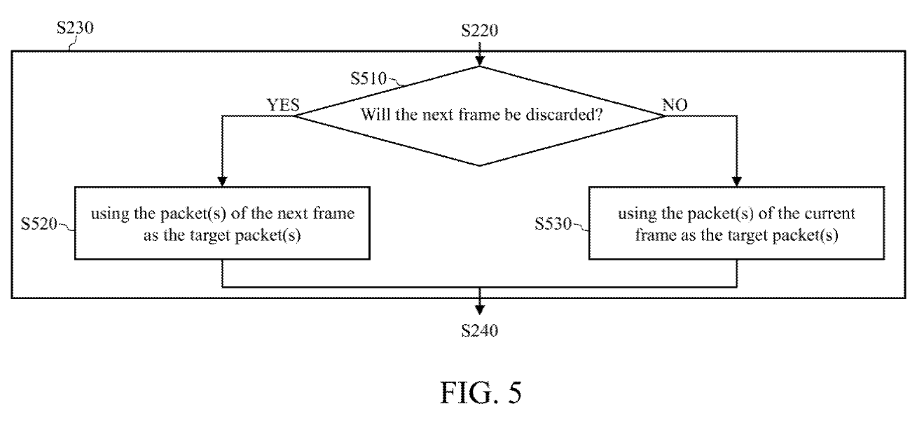

Reference is made to FIG. 4A, FIG. 4B, and FIG. 5. FIG. 4A and FIG. 4B are schematic diagrams of two application examples according to the present invention, and FIG. 5 shows sub-steps of step S230. The application examples of FIG. 4A and FIG. 4B may concern frame rate conversion, for example, by discarding the frame F_1 to convert from a high frame rate to a low frame rate. That is to say, originally between the time point t0 and the time point t3, the frames F_0, F_1, and F_2 were output; after the conversion, within the same period, only the frames F_0 and F_2 are output. In FIG. 4A, the frame F_0 originally (i.e., before the frame rate conversion) contains the packet PKT_0-0 and the packet PKT_0-1, while in FIG. 4B, the frame F_0 originally does not contain any packets. It should be noted that, since the frame F_2 needs to refer to the packets of the frame F_1 (including, but not limited to, the packet PKT_1-0 and the packet PKT_1-1), the packets of the frame F_1 after conversion should be retained; otherwise, the display at the backend (not shown in the figure) will encounter errors when displaying the frame F_2 (e.g., degraded image quality or even failure to display).

Note that a change in frame resolution (i.e., a change in frame size, for example, from 4K to 1080P) will also result in situations similar to those shown in FIG. 4A or FIG. 4B.

FIG. 5 corresponds to the application examples shown in FIG. 4A and FIG. 4B and includes the following steps.

Step S510: The control circuit 140 determines whether the next frame will be discarded. For example (referring to FIG. 4A or FIG. 4B), based on the conversion rate or the frame resolution, the control circuit 140 determines between the time point t0 and the time point t1 whether the next frame (i.e., the frame F_1) following the current frame (i.e., the frame F_0) will be discarded. If YES, then the flow proceeds to step S520; otherwise, the flow proceeds to step S530.

Step S520: The control circuit 140 uses the packet(s) (PKT_1-0, PKT_1-1) of the next frame (the frame F_1) as the target packet(s) PKT_K. For example (referring to FIG. 4A or FIG. 4B), because the next frame following the frame F_0 is the frame F_1, and the frame F_1 will be discarded, the target packets include the packet PKT_1-0 and the packet PKT_1-1, and the control circuit 140 provides the at least one target packet PKT_K to the transmission circuit 120. That is to say, after the adjustment, the image processing device 100 outputs the packet PKT_1-0 and the packet PKT_1-1 at the frame F_0, instead of outputting the packet PKT_0-0 and the packet PKT_0-1 (FIG. 4A) or not outputting any packets (FIG. 4B).

Step S530: Using the packet(s) of the current frame as the target packet(s). For example, if the current frame is the frame F_2, and the next frame following the frame F_2 (not shown in the figure) will not be discarded, then the target packets include the packet PKT_2-0 and the packet PKT_2-1, and the control circuit 140 provides the at least one target packet PKT_K to the transmission circuit 120. That is to say, the adjustment operation of step S230 includes retaining the at least one target packet. For another example, suppose that the frame F_2 does not contain any packets, and the next frame following the frame F_2 (not shown in the figure) will not be discarded. Because the information that “the frame F_2 does not contain any packets” is stored in the storage circuit 130 in step S225, the control circuit 140 will continue to maintain, in step S530, the state that the current frame (i.e., the frame F_2) contains no packets (i.e., the target packet is empty). That is to say, the adjustment operation in step S230 includes maintaining the state in which the current frame contains no packet.

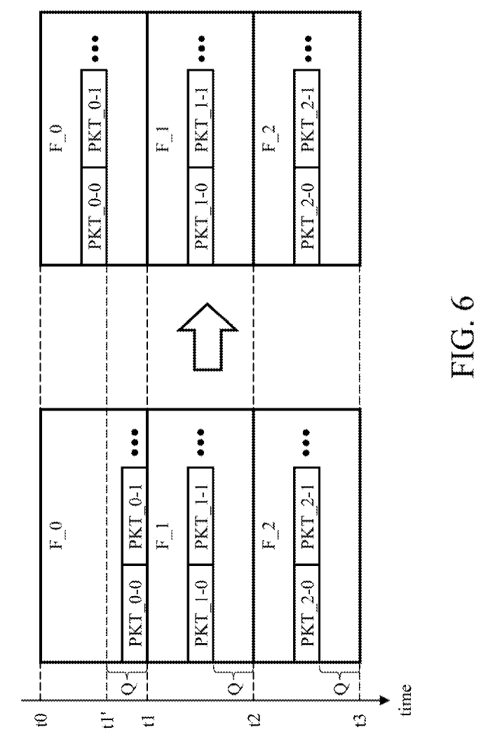

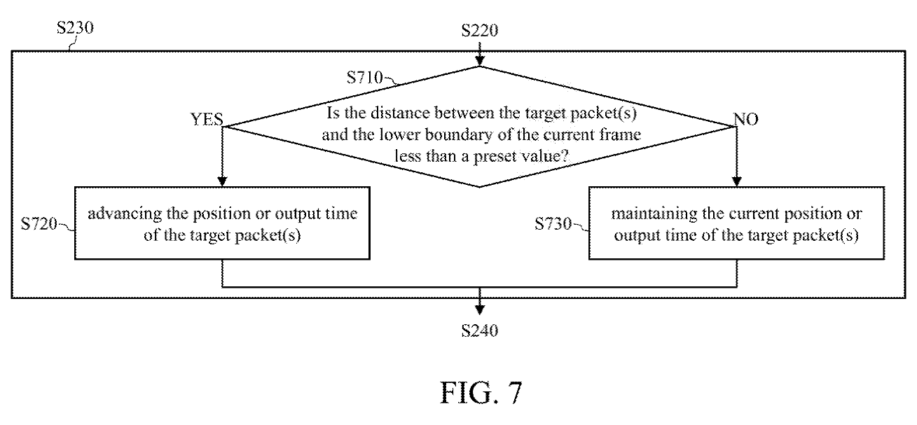

Reference is made to FIG. 6 and FIG. 7. FIG. 6 is a schematic diagram of another application example according to the present invention. FIG. 7 shows the sub-steps of step S230. In the application example of FIG. 6, the packets of the original frame F_0 (left column), including but not limited to the packet PKT_0-0 and the packet PKT_0-1, are transmitted too late, resulting in the backend display (not shown) being unable to process these packets in time. More specifically, the display needs to refer to the packet(s) of the frame F_0 when displaying the frame F_1, and an error occurs when the display cannot process the packet(s) of the frame F_0 in time.

FIG. 7 corresponds to the application example in FIG. 6 and includes the following steps.

Step S710: The control circuit 140 determines whether the distance between the target packet(s) and the lower boundary of the current frame is less than a preset value. If YES, then the flow proceeds to step S720; otherwise, the flow proceeds to step S730. For example, referring to FIG. 6, the preset value may be Q rows of pixels (where Q is a positive integer), or a transmission time corresponding to the Q rows of pixels (i.e., t1-t1', where the time point t1 corresponds to the lower boundary of the frame F_0 (i.e., the boundary between the frame F_0 and the frame F_1), and the time point t1' corresponds to the topmost row of the Q rows of pixels). When the current frame is the frame F_0 (in which case the target packets include the packet PKT_0-0 and the packet PKT_0-1), the result of step S710 is YES. When the current frame is the frame F_1 (in which case the target packets include the packet PKT_1-0 and the packet PKT_1-1) or the frame F_2 (in which case the target packets include the packet PKT_2-0 and the packet PKT_2-1), the result of step S710 is NO. In some embodiments, the time difference between the time point t1 and the time point t1' is the time required for the display to process the target packet(s).

Step S720: The control circuit 140 advances the position or output time of the target packet(s) so that the distance between the advanced target packet(s) and the lower boundary of the current frame is not less than the preset value. As shown in FIG. 6 (right column), the at least one target packet is advanced to the time point t1' or before, thus the display has sufficient time to process the at least one target packet.

Step S730: The control circuit 140 maintains the current position or output time of the target packet(s). For example, referring to FIG. 6, for the frame F_1, the position or output time of the packet PKT_1-0 and the packet PKT_1-1 does not change.

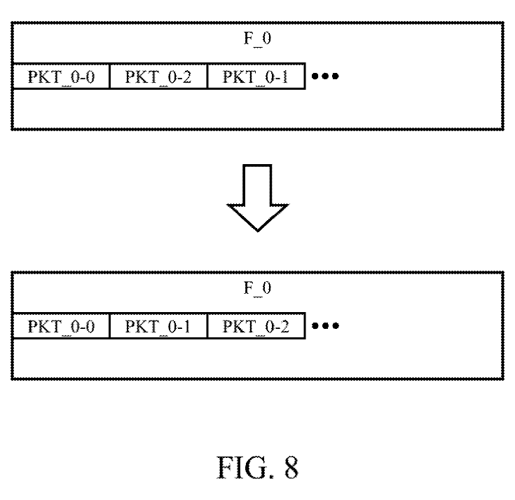

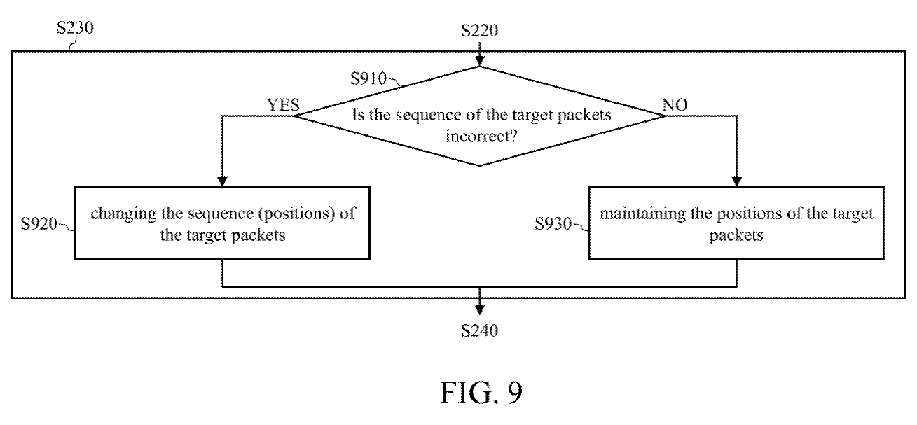

Reference is made to FIG. 8 and FIG. 9. FIG. 8 is a schematic diagram of another application example according to the present invention, and FIG. 9 shows the sub-steps of step S230. In the application example of FIG. 8, the sequence of the target packets of the current frame F_0 (including but not limited to PKT_0-0, PKT_0-2, PKT_0-1) is incorrect (the correct sequence is PKT_0-0→PKT_0-1→PKT_0-2), which causes errors in the image displayed by the display. In some embodiments, the packet PKT_0-0, the packet PKT_0-1, and the packet PKT_0-2 may be the extended metadata packets (EMP) of HDMI.

FIG. 9 corresponds to the application example of FIG. 8 and includes the following steps.

Step S910: The control circuit 140 determines whether the sequence of the target packets is incorrect. If YES, then the flow proceeds to step S920; otherwise, the flow proceeds step S930. Because the packet itself carries sequential information (e.g., the packet number), the control circuit 140 can make the determination based on that information.

Step S920: The control circuit 140 changes the sequence (positions) of the target packets. In the example of FIG. 8, the control circuit 140 exchanges the positions of the packet PKT_0-1 and the packet PKT_0-2, so that the adjusted target packets present the correct sequence.

Step S930: The control circuit 140 maintains the positions of the target packets.

In summary, the image processing device 100 of the present invention can prevent errors from occurring in a multimedia device or system during playback or display of images. In some embodiments, the image processing device 100 may be a repeater or a converter for a video interface.

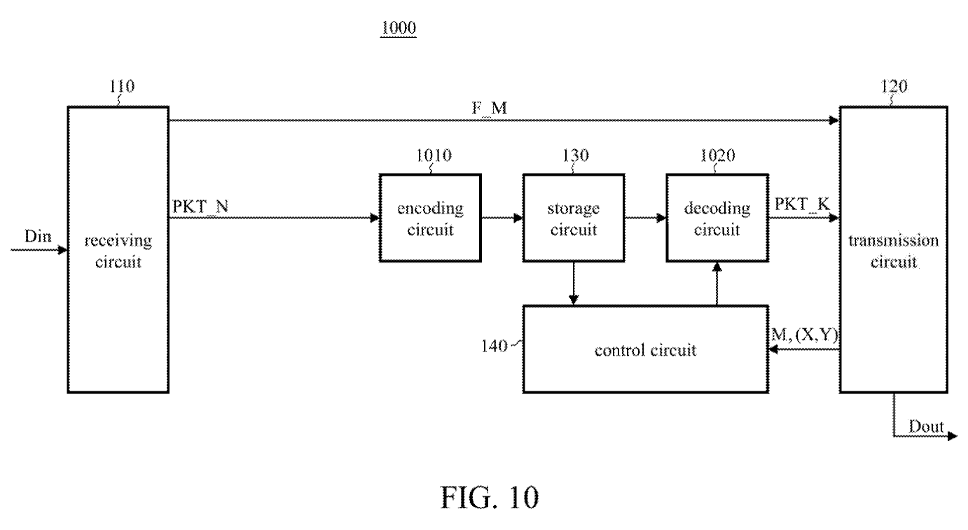

Reference is made to FIG. 10, which is a functional block diagram of the image processing device according to another embodiment of the present invention. In addition to the receiving circuit 110, the transmission circuit 120, the storage circuit 130, and the control circuit 140, the image processing device 1000 further includes an encoding circuit 1010 and a decoding circuit 1020. The encoding circuit 1010 is coupled between the receiving circuit 110 and the storage circuit 130. The decoding circuit 1020 is coupled between the storage circuit 130 and the transmission circuit 120, and is also coupled to the control circuit 140.

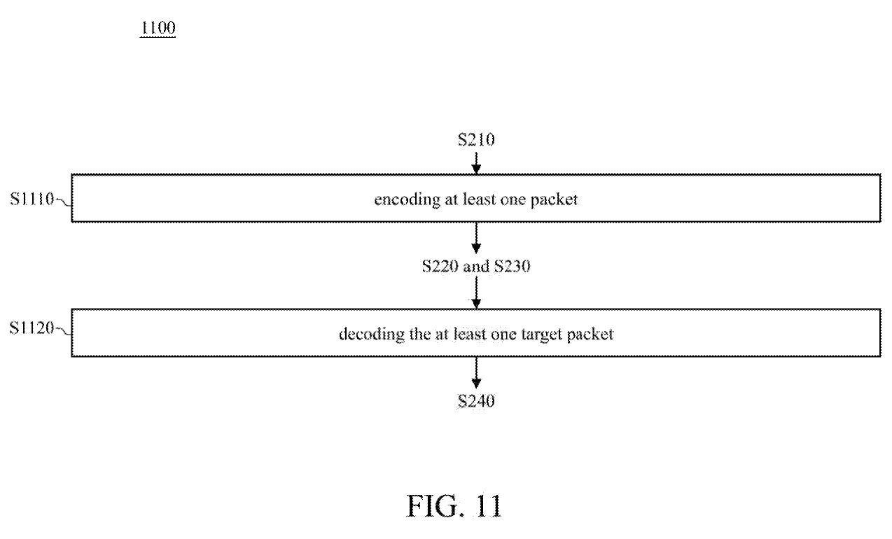

FIG. 11 is a flowchart of the image processing method according to another embodiment of the present invention. The image processing method 1100 in FIG. 11 can be executed by the image processing device 1000. In addition to steps S210 to S240, the flowchart in FIG. 11 further includes the following steps.

Step S1110: The encoding circuit 1010 encodes at least one packet to reduce the data amount of the packet. Step S1110 is executed before the storage of the packet (step S220). In some embodiments, the encoding circuit 1010 encodes the packet content and its position information (e.g., see FIG. 3, relative to the origin (0,0) of a frame), and then stores the encoded packet into the storage circuit 130. In an alternative embodiment, the encoding circuit 1010 compresses at least one packet, and then stores the compressed packet to the storage circuit 130.

Step S1120: The decoding circuit 1020 decodes the at least one target packet PKT_K to restore the target packet. More specifically, the decoding circuit 1020 performs a decoding operation based on a decoding scheme corresponding to the encoding scheme of the encoding circuit 1010, and then the decoded target packet is output (step S240).

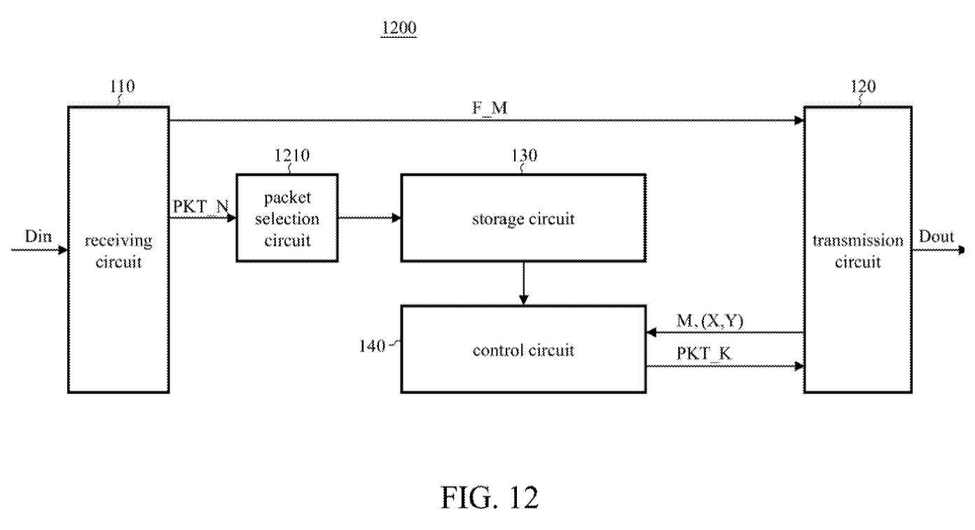

Reference is made to FIG. 12, which is a functional block diagram of an image processing device according to another embodiment of the present invention. In addition to the receiving circuit 110, the transmission circuit 120, the storage circuit 130, and the control circuit 140, the image processing device 1200 further includes a packet selection circuit 1210. The packet selection circuit 1210 is coupled between the receiving circuit 110 and the storage circuit 130. In some embodiments, the packet selection circuit 1210 includes a packet parser.

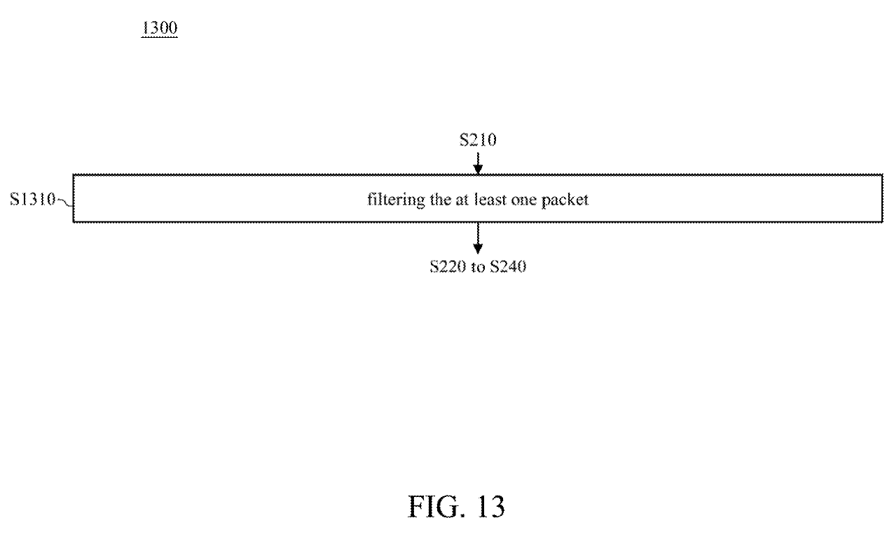

FIG. 13 is a flowchart of the image processing method according to another embodiment of the present invention. The image processing method 1300 of FIG. 13 can be executed by the image processing device 1200. In addition to the steps S210 to S240, the flowchart of FIG. 13 further includes the following steps.

Step S1310: The packet selection circuit 1210 filters the at least one packet. Step S1310 is performed before storing the packet (step S220). More specifically, by filtering the packets, the image processing device 1200 can process only packet(s) of interest (e.g., packet(s) related to HDR) to save the storage circuit 130 and reduce the processing time and/or power consumption of the image processing device 1200.

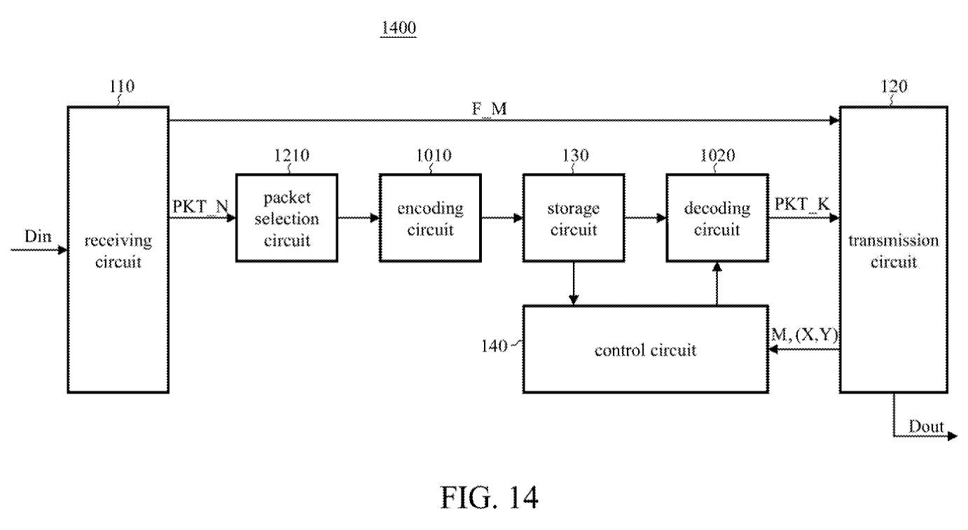

Reference is made to FIG. 14, which is a functional block diagram of an image processing device according to another embodiment of the present invention. The image processing device 1400 is a combination of the image processing device 1000 and the image processing device 1200. People having ordinary skill in the art can understand the details of the image processing device 1400 and its corresponding image processing method based on the discussion of FIG. 10 to FIG. 13.

In summary, the image processing device and the image processing method of the present invention can adjust the data packet(s) of the image data when necessary, so as to provide the correct data packet(s) at the appropriate time point(s), thereby avoiding display errors.

The examples in FIGS. 4A, 4B, and FIGS. 6-8 are intended to illustrate the invention by way of example and not to limit the scope of the claimed invention. People having ordinary skill in the art may apply the present invention to other situations where adjustment of data packets is needed, in accordance with the foregoing discussions.

Since a person having ordinary skill in the art can appreciate the implementation detail and the modification thereto of the present method invention through the disclosure of the device invention, repeated and redundant description is thus omitted. Note that the shape, size, and ratio of any element in the disclosed figures are exemplary for understanding, not for limiting the scope of this invention. Furthermore, there is no step sequence limitation for the method inventions as long as the execution of each step is applicable. In some instances, the steps can be performed simultaneously or partially simultaneously.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An image processing device for receiving an input image data comprising a plurality of frames, at least one frame of the plurality of frames comprising at least one packet, the image processing device comprising:
a receiving circuit receiving the input image data;
a storage circuit coupled to the receiving circuit and configured to store the at least one packet;
a transmission circuit coupled to the receiving circuit and configured to output a current output image data; and
a control circuit coupled to the storage circuit and the transmission circuit and configured to read at least one target packet from the storage circuit according to the current output image data, to adjust the at least one target packet, and then to output the at least one target packet through the transmission circuit.

2. The image processing device of claim 1, wherein the current output image data comprises a frame number of a current frame and a current pixel position that the transmission circuit is outputting.

3. The image processing device of claim 1, wherein the current output image data comprises a current playback time corresponding to a current pixel position of a current frame.

4. The image processing device of claim 1, wherein the current output image data comprises a current frame, and when the control circuit determines that a next frame following the current frame is to be discarded, the control circuit reads at least one packet of the next frame as the at least one target packet.

5. The image processing device of claim 1, wherein the current output image data comprises a current frame, and when the control circuit determines that a distance between the at least one target packet and a boundary of the current frame is less than a preset value, the control circuit advances a position or an output time of the at least one target packet, wherein the boundary is between the current frame and a next frame following the current frame.

6. The image processing device of claim 1, wherein the current output image data comprises a current frame, and when a sequence of the at least one target packet is incorrect, the control circuit changes the sequence of the at least one target packet.

7. The image processing device of claim 1, further comprising:
an encoding circuit coupled to the receiving circuit and the storage circuit and configured to encode the at least one packet; and
a decoding circuit coupled to the transmission circuit and the storage circuit and configured to decode the at least one target packet.

8. The image processing device of claim 7, further comprising:
a packet selection circuit coupled to the receiving circuit and the encoding circuit and configured to filter the at least one packet.

9. The image processing device of claim 1, wherein the storage circuit further stores a correspondence between the at least one packet and the at least one frame.

10. The image processing device of claim 1, wherein the input image data comprises a target frame, and when the target frame does not contain any packets, the storage circuit further records that the target frame does not contain any packets.

11. An image processing method, applied to an image processing device, the image processing device receiving an input image data comprising a plurality of frames, and at least one frame of the plurality of frames comprising at least one packet, the image processing method comprising:
receiving the input image data;
storing the at least one packet in a storage circuit; and
reading at least one target packet from the storage circuit according to a current output image data, adjusting the at least one target packet, and then outputting the at least one target packet.

12. The image processing method of claim 11, wherein the current output image data comprises a frame number of a current frame and a pixel position that the image processing device is outputting.

13. The image processing method of claim 11, wherein the current output image data comprises a current playback time corresponding to a current pixel position of a current frame.

14. The image processing method of claim 11, wherein the current output image data comprises a current frame, and the method further comprises:
reading at least one packet of a next frame following the current frame as the at least one target packet when determining that the next frame is to be discarded.

15. The image processing method of claim 11, wherein the current output image data comprises a current frame, and the method further comprises:
advancing a position or an output time of the at least one target packet when determining that a distance between the at least one target packet and a boundary of the current frame is less than a preset value, wherein the boundary is between the current frame and a next frame following the current frame.

16. The image processing method of claim 11, wherein the current output image data comprises a current frame, and the method further comprises:
changing a sequence of the at least one target packet when the sequence of the at least one target packet is incorrect.

17. The image processing method of claim 11, further comprising:
encoding the at least one packet before storing the at least one packet; and
decoding the at least one target packet after adjusting the at least one target packet.

18. The image processing method of claim 17, further comprising:
filtering the at least one packet before storing the at least one packet.

19. The image processing method of claim 11, further comprising:
storing a correspondence between the at least one packet and the plurality of frames.

20. The image processing method of claim 11, wherein the input image data comprises a target frame, and the method further comprises:
recording that the target frame does not contain any packets when the target frame does not contain any packets.
